(19) United States
(12) Patent Application Publication
(10) Pub. No.: US 2012/0254657 A1
(43) Pub. Date: Oct. 4, 2012

(54) DISK ARRAY DEVICE, CONNECTION PATH CONTROL METHOD AND CONNECTION PATH CONTROL PROGRAM

(75) Inventor: Norihiro KODAIRA, Tokyo (JP)

(73) Assignee: NEC Corporation, Tokyo (JP)

(21) Appl. No.: 13/433,174

(22) Filed: Mar. 28, 2012

(30) Foreign Application Priority Data
Mar. 30, 2011 (JP) 2011-075989

(51) Int. Cl. G06F 11/20

(52) U.S. Cl. 714/6.21; 714/E11.089

(57) ABSTRACT

Performance degradation caused by a failure occurring in a disk array device is suppressed. The disk array device comprises the dual structure controllers which are respectively connected to the host computer through the connection path, and a plurality of physical disks, wherein the controller comprises the failure sensing unit which senses a failure of the device, and the host interface control unit which, in a case where a failure is sensed by the failure sensing unit, when an inquire about a connection path to be preferentially used is made from the host computer, notifies the connection path connected to the other controller as a preferential path.

### TECHNICAL FIELD

The present invention relates to a disk array device and, more particularly, a technique for suppressing degradation of performance when the disk array device develops a fault.

### BACKGROUND ART

Among disk array devices having a dual controller structure is a disk array device having a function of, when a disk interface path develops a fault, blocking the path to continue a disk access by a controller of a reverse system and maintaining a host port of a controller at a redundant state, thereby enabling both controllers to continue processing of I/O from a host.

On this occasion, after the failure state of the disk interface path is removed, manually or automatically releasing a blocked state enables recovery to an original disk interface redundant state without stopping operation.

Memory management methods when a disk array device is structured to have a dual controller are classified into a global cache method and a local cache method.

Global cache method is to constantly manage information shared among controllers by simultaneously writing user data or control information into cache memories of both controllers.

On the other hand, in local cache methods, a cache memory of each controller independently manages information and only at the time of need such as user data writing or lack of information in the controller itself, executes data transfer between the controllers. In general, therefore, local cache methods have higher I/O performance.

In a case of a disk array device having a local cache method, however, a host I/O received by a controller whose disk interface path is blocked needs execution of communication and data transfer with a reverse system controller without fail, so that performance might be degraded as compared with the device in a normal state.

Solution to the problem includes a method of switching a main system path by an instruction from the side of a host designed to have a path management function and a method of switching a path by blocking the entire controller including a host port in which controller a disk path failure occurs.
Patent Literature 1: Japanese Patent Laying-Open No. 2001-216204.
Patent Literature 2: Japanese Patent Laying-Open No. 2001-325074.
Patent Literature 3: Japanese Patent Laying-Open No H11-312058.

The method of switching a main system path by an instruction from a host designed to have a path management function, however, has a problem of long-term performance degradation because of manual switching.

The method of switching a path by blocking the entire controller including a host port in which controller a disk path failure occurs has a problem of degradation in writing processing performance because the controller will lose redundancy to invalidate write cache.

### OBJECT OF THE PRESENT INVENTION

An object of the present invention is to solve the above-described problems and provide a disk array device, a connection path control method and a connection path control program which suppress performance degradation when the disk array device develops a fault.

### SUMMARY

According to a first exemplary aspect of the invention, a disk array device, includes dual structure controllers which are respectively connected to a host computer through connection paths, and a plurality of physical disks, wherein the controller comprises a failure sensing unit which senses a failure of the device, and a host interface control unit which, in a case where a failure is sensed by the failure sensing unit, when an inquire about the connection path to be preferentially used is made from the host computer, notifies the connection path connected to other the controller as a preferential path.

According to a second exemplary aspect of the invention, a connection path control method of a disk array device which comprises dual structure controllers respectively connected to a host computer through connection paths and a plurality of physical disks, wherein the controller comprises the steps of sensing a failure of the device, and in a case where a failure is sensed, when an inquiry about the connection path to be preferentially used is made from the host computer, notifying the connection path connected to other the controller as a preferential path.

According to a third exemplary aspect of the invention, a computer-readable medium storing a connection path control program operable on a disk array device which comprises dual structure controllers respectively connected to a host computer through connection paths and a plurality of physical disks, wherein the connection path control program causes the controller to execute the processing of sensing a failure of the device, and in a case where a failure is sensed, when an inquiry about the connection path to be preferentially used is made from the host computer, notifying the connection path connected to other the controller as a preferential path.

The present invention enables performance degradation to be suppressed when a failure occurs in a disk array device.

### BRIEF DESCRIPTION OF THE DRAWINGS

FIG. 1 is a diagram showing features of the present invention;

FIG. 2 is a diagram showing features of the present invention;

FIG. 3 is a block diagram showing a structure of a disk array device according to a first exemplary embodiment of the present invention;

FIG. 4 is a block diagram showing a structure of an information processing system comprising the disk array device according to the first exemplary embodiment;

FIG. 5 is a flow chart showing operation of the disk array device according to the first exemplary embodiment;

FIG. 6 is a flow chart showing operation of the disk array device according to the first exemplary embodiment;

FIG. 7 is a diagram showing an example of a structure of a state management table according to the first exemplary embodiment;

FIG. 8 is a diagram showing an example of a structure of the state management table according to the first exemplary embodiment;

FIG. 9 is a diagram showing an example of a structure of an ALUA management table according to the first exemplary embodiment;

FIG. 10 is a block diagram showing a minimum structure of the disk array device of the present invention; and

FIG. 11 is a block diagram showing an example of a hardware structure of the disk array device of the present invention.

### EXEMPLARY EMBODIMENT

The present invention is characterized in having a function of, when an internal failure occurs in a disk array device having a dual controller structure adopting a local cache method, appropriately switching a connection path with a host, thereby preventing reduction in I/O processing performance. Another characteristic is a function of switching to a connection path whose load distribution is optimized when the failure is recovered.

In order to exhibit the above-described characteristics, the present invention suppresses reduction in performance by implicitly switching a preferential access path (preferential path) to a logical disk (logical unit) on the side of the disk array device by using a function called Asymmetric Logical Unit Access (hereinafter referred to as ALUA) which is specified as a standard function of SCSI-3.

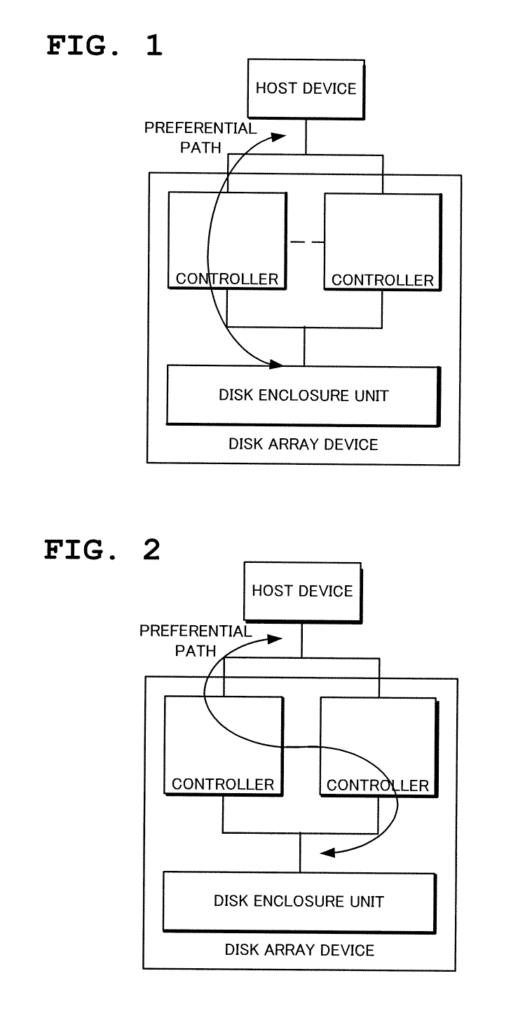

As shown in FIG. 1 and FIG. 2, the disk array device of the present invention has a function of sensing a disk interface failure and a means which enables sharing of failure information between controllers. At this time, in a case where a logical disk exists in which a controller of a redundant structure on a side where a disk path failure occurs is set as a preferential path, switching the preferential path to a side of a controller which develops no disk path failure in the disk array device results in switching of a connection path at the time of recognition of a preferential path from the host.

Switching of a preferential path leads to preferential issuance of an I/O from the host to the side of the controller where no failure occurs and execution of processing of the same. As compared with a conventional method in which data transfer is required between controllers without fail, communication between controllers can be minimized to enable performance degradation of host I/O processing due to a disk path failure to be suppressed.

In ALUA, a SET TARGET PORT GROUPS command and a REPORT TARGET PORT GROUPS command are defined.

By the SET TARGET PORT GROUPS command, preferential path information can be explicitly set to the disk array device from the host and by the REPORT TARGET PORT GROUPS command, preferential path information is reported on a logic disk basis.

Preferential path can be also implicitly switched in the disk array device and reporting the switching by the REPORT TARGET PORT GROUPS command enables switching of preferential path setting from the side of the disk array device as well.

For clarifying the above and other objects, features and advantages of the present invention, an exemplary embodiment of the present invention will be detailed in the following with reference to the drawings as attached. Other than the above-described objects of the present invention, other technical problems, and means for solving the problems and their functions and effects will become apparent from the following disclosure of the exemplary embodiment.

In all the drawings, like components are allotted like reference numerals to appropriately omit their description.

### First Exemplary Embodiment

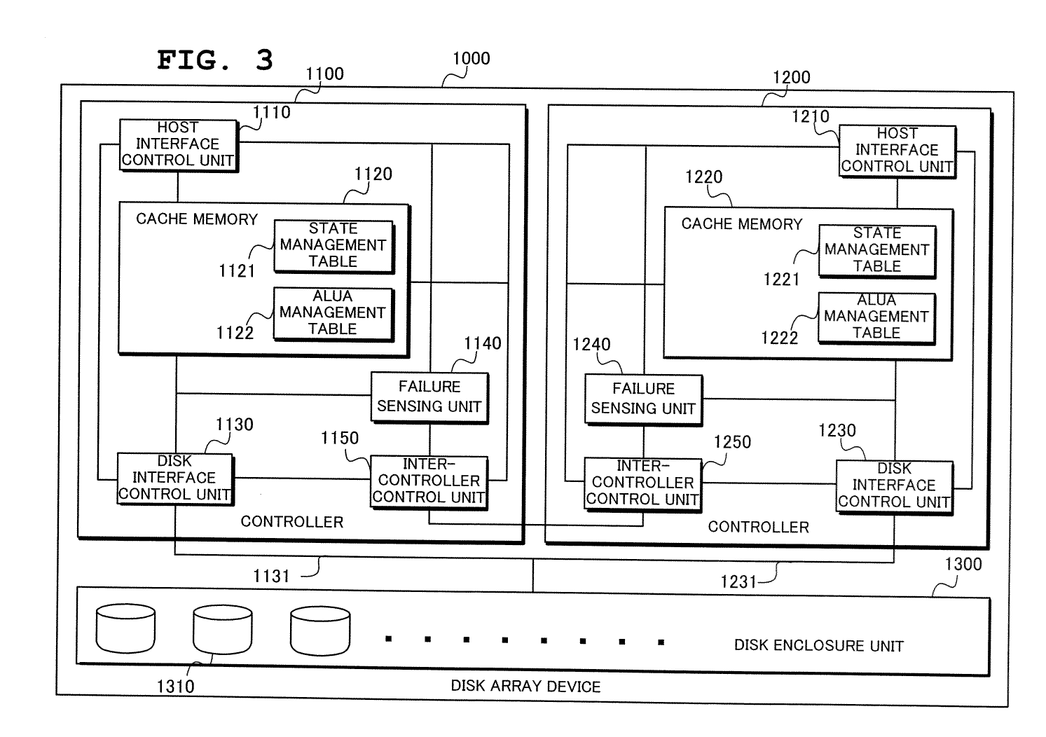

FIG. 3 is a block diagram showing a structure of a disk array device 1000 according to a first exemplary embodiment of the present invention.

With reference to FIG. 3, the disk array device 1000 according to the present exemplary embodiment comprises controllers 1100 and 1200 as a redundant structure.

The disk array device 1000 contains a disk enclosure unit 1300 on which a plurality of physical disks 1310 are mounted. The disk array device 1000 is an SCSI device which supports both implicit switching and explicit switching of ALUA as a standard function of SCSI-3.

The controller 1100 comprises a host interface control unit 1110, a cache memory 1120, a disk interface control unit 1130, a failure sensing unit 1140 and an inter-controller control unit 1150. Functions of the controllers 1100 and 1200 are the same.

The host interface control unit 1110, the disk interface control unit 1130, the failure sensing unit 1140 and the inter-controller control unit 1150 are allowed to read and write data on the cache memory 1120.

More specifically, on the cache memory 1120, a state management table 1121 is placed which is capable of managing a state of each of the controllers 1100 and 1200 of the disk array device 1000.

The inter-controller control units 1150 and 1250 synchronize the state management tables 1121 and 1221. Therefore, the inter-controller control units 1150 and 1250 are being synchronized.

More specifically, when information is updated in the state management table 1221 on the side of the controller 1200, the inter-controller control unit 1250 is allowed to read data from the state management table 1221 and send the data to the side of the controller 1100. The inter-controller control unit 1150 on the side of the controller 1100 is allowed to write the sent data into the cache memory 1121.

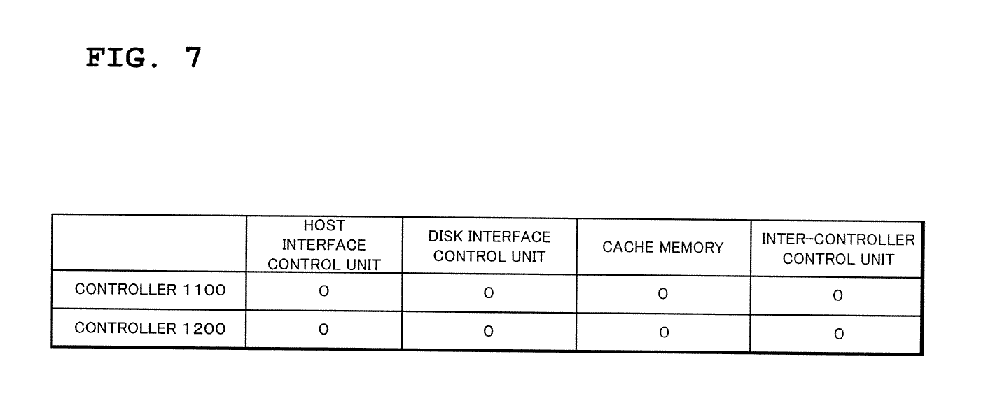

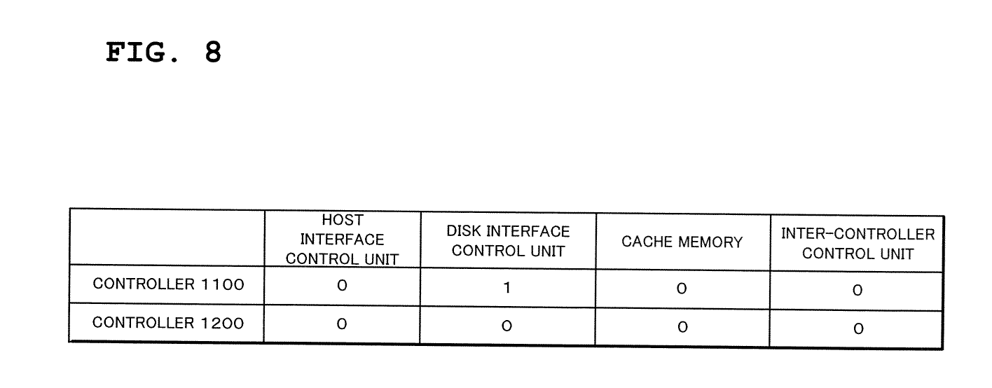

The state management tables 1121 and 1221 are, for example, as shown in FIG. 7 and FIG. 8, and the host interface control unit 1110, the disk interface control unit 1130 and the inter-controller control unit 1150 are allowed to read, by using the state management table 1121, that the disk interface control unit 1130 of the controller 1100 operates normally and that a disk interface control unit 1230 on the side of a reverse system controller operates normally.

On the cache memory 1120, other than the state management table 1121, an ALUA management table 1122 is provided which manages preferential path information with a host on a logical disk basis as shown in FIG. 9. The information is synchronized between both controllers 1100 and 1200.

The failure sensing unit 1140 has a function of monitoring and sensing a failure state in the controller 1100. Also provided is a function of sensing a failure state of the host interface control unit 1110 and the disk interface control unit 1130 and updating the state management table 1121 on the cache memory 1120.

The disk interface control unit 1130 and the disk enclosure unit 1300 are connected by using a path 1131. The disk interface control unit 1230 on the side of another controller 1200 is also connected with the disk enclosure unit 1300 by a path 1231, so that information of the physical disk 1310 is shared by the controllers 1100 and 1200.

At this time, when the path 1131 develops a failure, it is determined to be a failure of the disk interface control unit 1130. Failure of the disk interface control unit 1130 itself is also determined to be a failure of the disk interface control unit 1130.

A plurality of logical disks can be structured by the physical disks 1310.

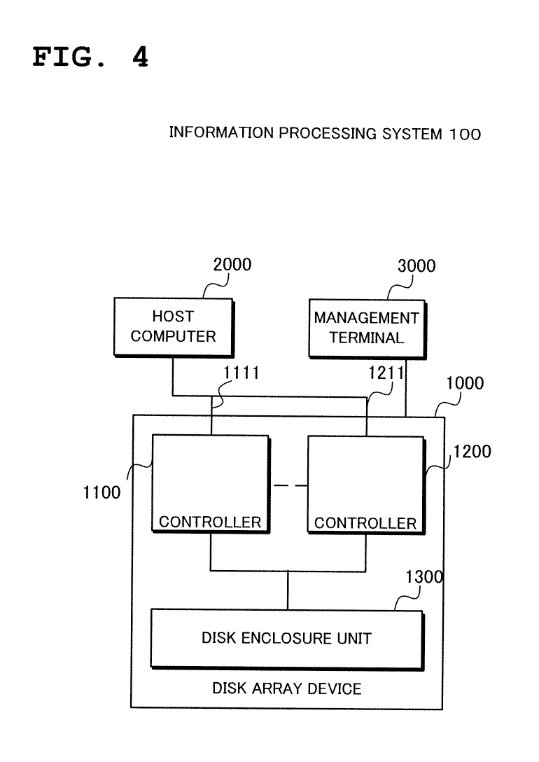

FIG. 4 is a block diagram showing a structure of an information processing system 100 comprising the disk array device 1000 according to the first exemplary embodiment of the present invention. The information processing system 100 is formed of a host computer 2000, a management terminal 3000 and the disk array device 1000.

The disk array device 1000 and the host computer 2000 are connected with the respective controllers 1100 and 1200 by host connection paths 1111 and 1211.

The host computer 2000 is a device which has an ALUA function and supports SET TARGET PORT GROUPS and REPORT TARGET PORT GROUPS.

The disk array device 1000 is a device having a function of returning specific information to a REPORT TARGET PORT GROUPS command of ALUA periodically issued from the host and a function of setting a preferential path of an arbitrary logical disk by a SET TARGET PORT GROUPS command.

The host computer 2000 determines a preferential path from the connection paths 1111 and 1211 for an arbitrary logical disk based on returned information.

### (Description of Operation of the First Exemplary Embodiment)

Next, operation of the disk array device 1000 according to the present exemplary embodiment will be detailed with reference to the drawings.

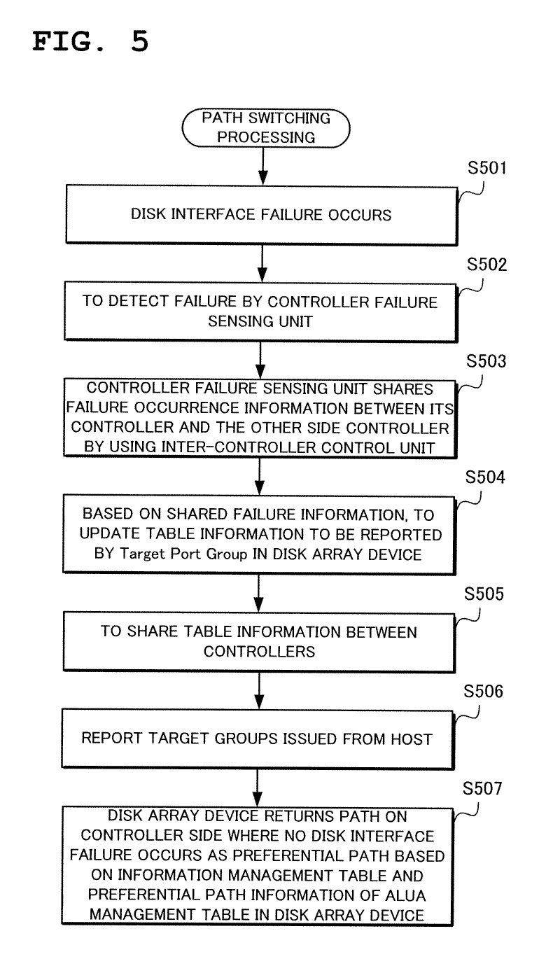

FIG. 5 is a flow chart of preferential path switching in the disk array device 1000 at the time of a disk interface failure.

Shown in FIG. 5 is an example where when the connection path 1111 between the host computer 2000 and the controller 1100 is set as a preferential path for a certain logical disk, the controller 1100 develops a disk interface failure to cause switching of a preferential path.

When either the disk interface control unit 1130 or the path 1131 between the disk interface control unit 1130 and the disk enclosure unit 1300 develops a fault, the disk interface control unit 1130 enters a failure state (Step S501).

When the failure develops, the failure sensing unit 114U writes the failure state of the disk interface control unit 1130 in the state management table 1121 on the cache memory 1120 (Step S502).

The information of the state management table 1121 is rewritten to have “1” as shown in FIG. 8 from the failure-yet-to-occur state shown in FIG. 7 in order to notify the failure of the disk interface control unit 1130 of the controller 1100.

When the state management table 1121 is updated, the update is informed from the inter-controller control unit 1150 to the inter-controller control unit 1250 (Step S503). As information on the transmission side, information of the state management table 1121 may be sent as it is or only an updated part of the information may be sent.

The inter-controller control unit 1250 having received the information updates the information of the state management table 1221 on the cache memory 1220 by the reverse system side information received (i.e. the information of the state management table 1121) (Steps S504 and S505).

From the host computer 2000, a REPORT TARGET PORT GROUPS command as an ALUA command is periodically issued (Step S506). At this time, the host interface control unit which will receive the REPORT TARGET PORT GROUPS command from the host computer 2000 may be 1110 or 1210.

For example, upon receiving the REPORT TARGET PORT GROUPS command, the host interface control unit 1110 refers to the state management table 1121 and the ALUA management table 1122, generates preferential path information for a logical disk for which the command has been issued and returns the information to the host computer 2000 as a response to the REPORT TARGET PORT GROUPS command (Step S507).

At this time, even when the connection path 1111 is set as a preferential path, because the controller 1100 develops a disk interface failure, the host interface control unit 1110 determines the connection path 1211 as a preferential path.

The host computer 2000 having received the preferential path information is allowed to preferentially use the switched connection path 1211 to continue I/O processing.

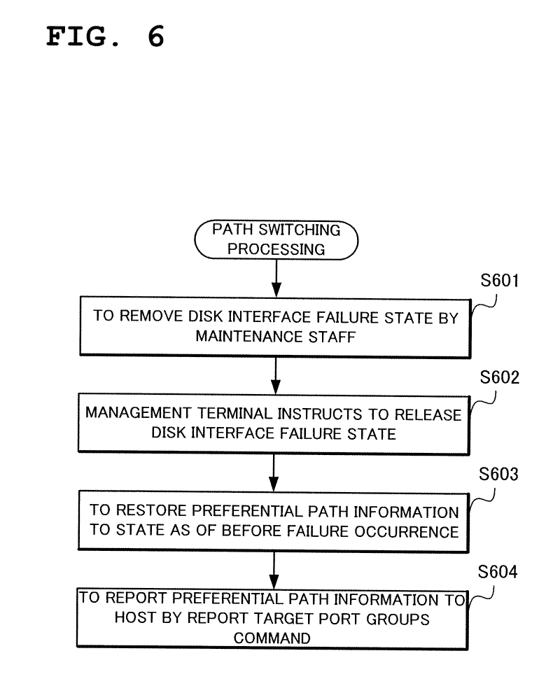

FIG. 6 is a flow chart showing preferential path switch back processing in the disk array device 1000 to be executed when a failure occurs after recovery of a disk interface failure.

After a factor in a disk interface failure is removed by a maintenance staff or the like (Step S601), when the management terminal 3000 issues a disk interface failure state release instruction (Step S602), failure information of the disk interface control unit of the state management table 1121 on the cache memory 1120 is updated to the normal state (Step S603).

Hereinafter, the disk array device 1000 is allowed to return preferential path information as of before the failure occurrence (Step S604). Since the host computer 2000 executes I/O access based on the preferential path information obtained by the REPORT TARGET PORT GROUPS command, loads of a controller on which loads are concentrated due to a disk interface path failure can be dispersed.

### (Effects of the First Exemplary Embodiment)

According to the present exemplary embodiment, since even when a disk path failure occurs in a disk array device adopting a local cache method, host preferential path setting is automatically executed so as to prevent data transfer between controllers, performance degradation caused by data transfer between the controllers can be suppressed.

In the present exemplary embodiment, since when a disk path failure is recovered, preferential path information to be returned to the host is restored to information as of before the occurrence of the failure to switch to preferential path setting with loads dispersed, it is possible to prevent I/O processing from concentrating on one controller, thereby optimizing performance.

Although in the present exemplary embodiment, the method of recovering the blocked state of the disk path is executed by an instruction from the management terminal to restore the report of host preferential path setting to an original state, responding to a report from the host can be made after automatically releasing the block state upon confirming recovery of a disk path failure not by an instruction from the terminal but by path analysis and updating a preferential path with the host to an original state within the device.

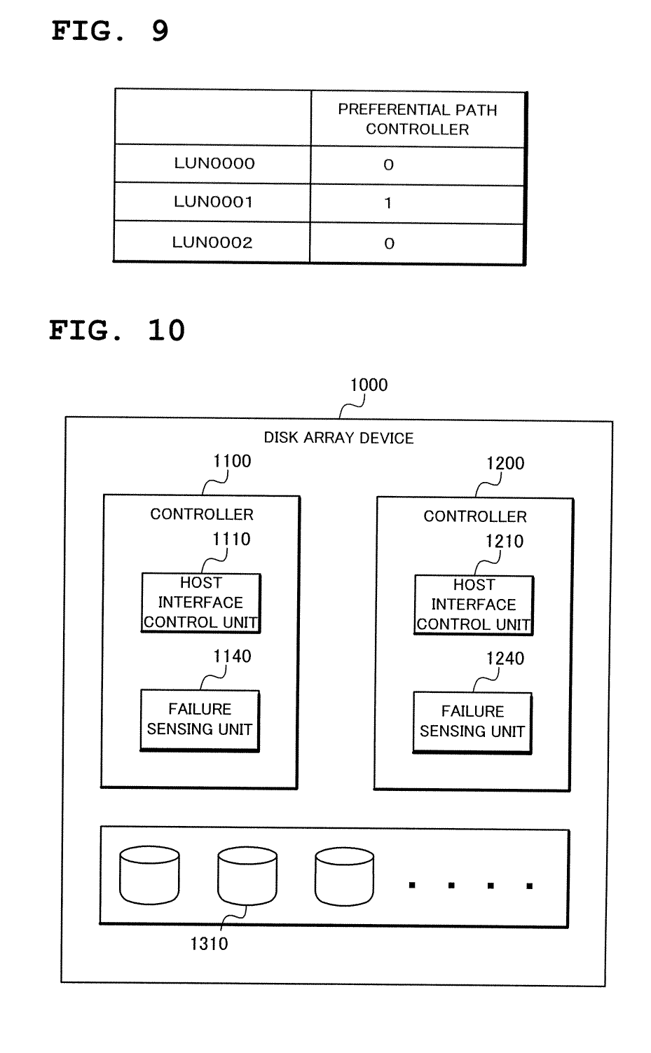

Minimum structure which enables the problems of the present invention to be solved is shown in FIG. 10. The disk array device 1000 is the disk array device 1000 comprising the controllers 1100 and 1200 of a dual structure which are connected to the host computer 2000 through the connection paths 1111 and 1211, respectively, and a plurality of physical disks 1310, in which the controller 1100 or 1200 is designed to comprise the failure sensing unit 1140 or 1240 which senses a failure of the device, and the host interface control unit 1110 or 1210 which, when a failure is sensed by the failure sensing unit 1140 or 1240, if the host computer 2000 inquires about a connection path to be preferentially used, notifies a connection path connected to the other controller 1100 or 1200 as a preferential path, thereby solving the above-described problems of the present invention.

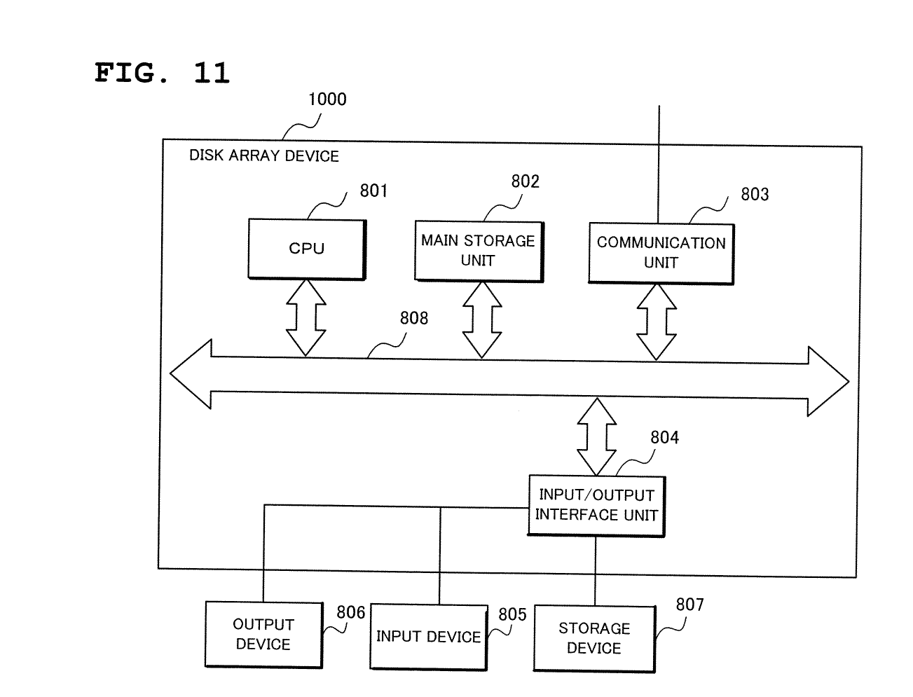

Next, description will be made of an example of a hardware structure of the disk array device 1000 of the present invention with reference to FIG. 11. FIG. 11 is a block diagram showing an example of a hardware structure of the disk array device 1000 of the present invention.

With reference to FIG. 11, the disk array device 1000 of the present invention, which has the same hardware structure as that of a common computer device, comprises a CPU (Central Processing unit) 801, a main storage unit 802 formed of a memory such as a RAM (Random Access Memory) for use as a data working region or a data temporary saving region, a communication unit 803 which transmits and receives data through a network, an input/output interface unit 804 connected to an input device 805, an output device 806 and a storage device 807 to transmit and receive data, and a system bus 808 which connects each of the above-described components with each other. The storage device 807 is realized by a hard disk device or the like which is formed of a non-volatile memory such as a ROM (Read Only Memory), a magnetic disk or a semiconductor memory.

Each function of the disk array device 1000 of the present invention can be realized not only in hardware by mounting a circuit part as a hardware part such as an LSI (Large Scale Integration) with a program incorporated but also in software by storing a program which provides the functions in the storage device 807, loading the program into the main storage unit 802 and executing the same by the CPU 801.

While the present invention has been described with respect to the preferred exemplary embodiment in the foregoing, such is for illustrative purpose only and it is not to be construed limitative. Modification and variation of the present invention will be obvious within the scope of its technical idea.

Arbitrary combination of the foregoing components and conversion of the expressions of the present invention to/from a method, a device, a system, a recording medium, a computer and the like are also available as a mode of the present invention.

In addition, the various components of the present invention need not always be independent from each other and a plurality of components may be formed as one member, or one component may be formed by a plurality of members, or a certain component may be a part of other component, or a part of a certain component and a part of other component may overlap with each other, or the like.

While the method and the computer program of the present invention have a plurality of procedures recited in order, the order of recitation is not a limitation to the order of execution of the plurality of procedures. When executing the method and the computer program of the present invention, therefore, the order of execution of the plurality of procedures can be changed without hindering the contents.

The plurality of procedures of the method and the computer program of the present invention are not limitedly executed at timing different from each other. Therefore, during the execution of a certain procedure, other procedure may occur, or a part or all of execution timing of a certain procedure and execution timing of other procedure may overlap with each other, or the like.

### INCORPORATION BY REFERENCE

This application is based upon and claims the benefit of priority from Japanese patent application No. 2011-075989, filed on Mar. 30, 2011, the disclosure of which is incorporated herein in its entirety by reference.

1. A disk array device, comprising:
dual structure controllers which are respectively connected to a host computer through connection paths; and
a plurality of physical disks, wherein
said controller comprises
a failure sensing unit which senses a failure of the device, and
a host interface control unit which, in a case where a failure is sensed by said failure sensing unit, when an inquire about said connection path to be preferentially used is made from said host computer, notifies said connection path connected to other said controller as a preferential path.

2. The disk array device according to claim 1, wherein
said controller comprises
a state management table which holds information of a failure sensed by said failure sensing unit, and
an inter-controller control unit which notifies, when information of said state management table is updated, the updated information to other said controller,
said inter-controller control unit,
when receiving said updated information from other said controller, updating said state management table of the device based on the updated information.

3. The disk array device according to claim 1, which employs a local cache method.

4. A connection path control method of a disk array device which comprises dual structure controllers respectively connected to a host computer through connection paths and a plurality of physical disks, wherein said controller comprises
sensing a failure of the device, and
in a case where a failure is sensed, when an inquiry about said connection path to be preferentially used is made from said host computer, notifying said connection path connected to other said controller as a preferential path.

5. The connection path control method according to claim 4, wherein said controller comprises:
when information of a state management table which holds information of a failure sensed by said failure sensing unit is updated, notifying the updated information to other said controller, and
when receiving said updated information from other said controller, updating said state management table of the device based on the updated information.

6. The connection path control method according to claim 4, which employs a local cache method.

7. A computer-readable medium storing a connection path control program operable on a disk array device which comprises dual structure controllers respectively connected to a host computer through connection paths and a plurality of physical disks, wherein said connection path control program causes said controller to execute the processing of:
sensing a failure of the device, and
in a case where a failure is sensed, when an inquiry about said connection path to be preferentially used is made from said host computer, notifying said connection path connected to other said controller as a preferential path.

8. The computer-readable medium according to claim 7, wherein said connection path control program causes said controller to execute the processing of:
when information of a state management table which holds information of a failure sensed by said failure sensing processing is updated, notifying the updated information to other said controller, and
when receiving said updated information from other said controller, updating said state management table of the device based on the updated information.

9. The computer-readable medium according to claim 7, wherein said connection path control program employs a local cache method.

10. The disk array device according to claim 2, which employs a local cache method.

11. The connection path control method according to claim 5, which employs a local cache method.

12. The computer-readable medium according to claim 8, wherein said connection path control program employs a local cache method.
